(19) United States
(12) Patent Application Publication
(10) Pub. No.: US 2020/0005321 A1
(43) Pub. Date: Jan. 2, 2020

(54) METHOD FOR PAYMENT BASED ON BIOMETRICS, USER EQUIPMENT AND SYSTEM FOR PAYMENT USING THE SAME

(71) Applicant: LG ELECTRONICS INC., Seoul (KR)

(72) Inventors: Tae Hyun KIM, Seoul (KR); Beom Oh KIM, Seoul (KR)

(73) Assignee: LG ELECTRONICS INC., Seoul (KR)

(21) Appl. No.: 16/562,386

(22) Filed: Sep. 5, 2019

(30) Foreign Application Priority Data
May 29, 2019 (KR) 10-2019-0063316

(51) Int. Cl. G06Q 20/40; G06Q 20/38; G06F 1/16

(52) U.S. Cl. CPC G06Q 20/40145; G06F 1/163; G06Q 20/3821

(57) ABSTRACT

A payment method based on biometric information is disclosed. The payment method includes: performing, by a user device, a communication connection with an electronic payment device, receiving biometric information of a payer detected by the electronic payment device, authenticating the payer by using the biometric information of the payer, and transmitting payment specific information to the electronic payment device when the payer authentication is successful.

### CROSS-REFERENCE TO RELATED APPLICATION

Pursuant to 35 U.S.C. § 119(a), this application claims the benefit of earlier filing date and right of priority to Korean Patent Application No. 10-2019-0063316, filed on May 29, 2019, the contents of which are hereby incorporated by reference herein in its entirety.

### TECHNICAL FIELD

The present disclosure relates to a payment method based on biometrics, and a user device and a payment system using the payment method based on biometrics. More particularly, the present disclosure relates to a payment method in which biometric information can be used as an measure for authentication via a body area network (BAN) without disclosing the biometric information, and a user device and a payment system using the payment method based on biometrics.

### BACKGROUND ART

Credit cards have long replaced cash, which is the most basic method of payment in many areas of face-to-face and online payments. A change is occurring in payment systems where credit cards, which replaced cash due to the convenience of credit cards, are being partially replaced by mobile cards due to the same reason.

A plastic credit card has a physical form, thereby making possession of the credit card itself during face-to-face payment a possible primary measure for user authentication. As a secondary and tertiary measure for user authentication, collating a signature on the back of the credit card with a handwritten signature or checking an identification card of a credit card holder is possible. However, the credit card has a disadvantage in that carrying the credit card itself can be inconvenient, and accordingly the appearance of mobile cards compensates for the disadvantage.

There are two types of mobile cards: a universal subscriber identity module (USIM) card that uses payment information stored in a USIM chip of a mobile phone and an AppCard that is based on an application installed in a mobile phone. The inconvenience of carrying credit cards has decreased due to mobile cards, but there still exists the inconvenience of inputting a password as a measure for user authentication.

Biometric information, especially fingerprint recognition technology, is being used for user authentication. However, in order to authenticate a user using collation of biometric information, it is inevitable to disclose the user's biometric information in the form of a public key, resulting in a risk of leakage of personal information.

Korean Patent Application Publication No. 10-2013-0050039, entitled “Method and System for Credit Card Payment by Authenticating Biometric Information” (hereinafter referred to as “Related Art 1”) discloses a credit card payment system using biometric information and a method thereof. However, there is a risk that personal biometric information may be leaked in the process of collecting a template required for user authentication since a template stored in a credit card is used.

In addition, Korean Patent Application Publication No. 10-2001-0098561, entitled “Credit Card Settlement System and Method for Biometric Information Use” (hereinafter referred to as “Related Art 2”) discloses a credit card payment system using biometric information and a method thereof. However, personal biometric information must be registered in a credit card payment server in advance, therefore a risk of leakage of personal biometric information by a third party still exists.

### RELATED ART DOCUMENT

Related Art 1: Korean Patent Application Publication No. 10-2013-0050039 (published on May 15, 2013)
Related Art 2: Korean Patent Application Publication No. 10-2001-0098561 (published on Nov. 8, 2001)

### DISCLOSURE OF INVENTION

### Technical Problem

The present disclosure is directed to providing a payment method in which personal biometric information can be used as a measure for user authentication in a state where the personal biometric information is not disclosed to a third party, and a user device using the payment method.

The present disclosure is further directed to providing a payment method in which personal body information can be used as a measure for user authentication required for a payment via a body area network (BAN), and a user device using the payment method.

The present disclosure is not limited to the above-described aspects, and other aspects and advantages of the present disclosure can be appreciated by those skilled in the art based on the following description and will be understood more clearly from embodiments of the present disclosure. In addition, it will be appreciated that the aspects and advantages of the present disclosure will be easily realized by those skilled in the art based on the appended claims and a combination thereof.

### Solution to Problem

A payment method based on biometric information according to an embodiment of the present disclosure may include performing, by a user device 100, authentication by determining whether a holder of the user device 100 is identical to a holder of payment specific information stored in the user device 100.

Further, the payment method based on biometric information may include performing a communication connection between the user device 100 and an electronic payment device via a wireless body area network (WBAN).

Further, the payment method based on biometric information may perform authentication by determining whether the holder of the user device 100 is a holder of a legal measure of electronic payment in a state where a template of a user is stored in the user device 100 without disclosing the template of the user in the form of a public key.

Further, the payment method based on biometric information may include encrypting biometric information of the user collected by an electronic payment device of a business operator corresponding to a merchant.

Further, the payment method may include performing, by the user device, the communication connection with the electronic payment device, receiving biometric information of a payer detected by the electronic payment device, authenticating the payer by using the biometric information of the payer, and transmitting payment specific information to the electronic payment device when the payer authentication is successful.

The payment method according to this embodiment of the present disclosure may further include storing, in advance, a template required for the payer authentication. The authenticating the payer may include determining whether the template and the biometric information of the payer are consistent with each other.

Further, the storing, in advance, the template may include receiving the template from a user terminal.

The payment method according to this embodiment of the present disclosure may further include searching the template. When the template is not found in a local area, the payment method may further include downloading the template from an authentication center.

Further, the downloading the template may include connecting with the authentication center via a network, determining whether the template is registered, and downloading the template, when the template is registered.

Further, the performing, by the user device, the communication connection with the electronic payment device may include performing the communication connection via a body area network (BAN).

Further, the authenticating the payer by using the biometric information of the payer may include verifying whether the biometric information of the payer and the template are consistent with each other.

Further, the biometric information may include at least one selected from a group of information about a face, information about a fingerprint, information about an iris, information about a retina, information about a voice, information about a vein, information about a hand shape, and information about an ear shape.

Further, the payment method according to this embodiment of the present disclosure may further include discarding the payment specific information, when the payer authentication fails a predetermined number of times.

Further, the biometric information of the payer detected by the electronic payment device may be transmitted to the user device of the payer without being stored in the electronic payment device.

A payment method performed by an electronic payment device according to another embodiment of the present disclosure may include performing a communication connection with a user device of a payer by the electronic payment device, detecting biometric information of the payer, transmitting the biometric information to the user device, and receiving payment specific information from the user device of the payer via a BAN.

Further, the performing the communication connection with the user device of the payer by the electronic payment device may include performing the communication connection via the BAN.

Further, the biometric information may include at least one selected from a group of information about a face, information about a fingerprint, information about an iris, information about a retina, information about a voice, information about a vein, information about a hand shape, and information about an ear shape.

A user device according to another embodiment of the present disclosure may include a communication unit configured to perform a communication connection with an electronic payment device and receive biometric information of a payer detected by the electronic payment device, and a processor configured to perform payer authentication by using the biometric information of the payer. When the payer authentication is successful, the processor may control the communication unit so as to transmit payment specific information to the electronic payment device via a BAN.

Further, the user device according to this embodiment of the present disclosure may further include a memory configured to store a template required for the payer authentication. The processor may determine whether the template stored in advance and the biometric information of the payer are consistent with each other.

Further, the processor may control the communication unit so as to receive the template from a user terminal of the payer.

Further, the processor may search the template. When the template is not found in a local area, the processor may control the communication unit so as to download the template from an authentication center.

Further, the communication unit may perform the communication connection with the electronic payment device via the BAN.

Further, the processor may authenticate the payer by verifying whether the biometric information of the payer and the template are consistent with each other.

Further, the biometric information may include at least one selected from a group of information about a face, information about a fingerprint, information about an iris, information about a retina, information about a voice, information about a vein, information about a hand shape, and information about an ear shape.

Further, the processor may discard the payment specific information, when the payer authentication fails a predetermined number of times.

Further, the biometric information of the payer detected by the electronic payment device may be transmitted to the user device of the payer without being stored in the electronic payment device.

A payment system according to another embodiment of the present disclosure may include a user device of a payer configured to perform payer authentication by determining whether a template stored in advance and biometric information of the payer detected are consistent with each other and supply specific information about the payer to a payment, and an electronic payment device configured to generate biometric information of the payer and proceed with payment by using the specific information about the payer received according to the payer authentication.

### Advantageous Effects of Invention

According to the present disclosure, authenticating a user by using biometric information of the user without disclosing the biometric information of the user is possible, and thereby there is no fear of leakage of personal information.

In addition, performing user authentication required for payment via a BAN and by using biometric information is possible.

### BRIEF DESCRIPTION OF DRAWINGS

FIG. 1 is an exemplary view of a network environment of a payment system based on biometrics according to an embodiment of the present disclosure.

FIG. 2 is an exemplary view of a user device and an electronic payment device according to an embodiment of the present disclosure.

FIG. 3 is a block diagram of a user device according to an embodiment of the present disclosure.

FIG. 4 is a flowchart of a payment method based on biometrics according to an embodiment of the present disclosure.

FIG. 5 is a flowchart of a payment method according to an embodiment of the present disclosure described in the aspect of an electronic payment device.

FIG. 6 is a flowchart of a payment method based on biometrics according to an embodiment of the present disclosure.

### DESCRIPTION OF EMBODIMENTS

Hereinafter, embodiments of the present disclosure will be described in detail with reference to the accompanying drawings. Like reference numerals refer to the like elements throughout and a duplicate description thereof is omitted. Suffixes “module” and “unit or portion” for elements used in the following description are merely provided for facilitation of preparing this specification, and thus they are not granted a specific meaning or function. In relation to describing the present disclosure, when the detailed description of the relevant known technology is determined to unnecessarily obscure the gist of the present disclosure, the detailed description may be omitted. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

Although the terms first, second, third, and the like, may be used herein to describe various elements, components, regions, layers, and/or sections, these elements, components, regions, layers, and/or sections should not be limited by these terms. These terms may be only used to distinguish one element, component, region, layer, or section from another region, layer, or section.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion, such as “between” versus “directly between,” “adjacent” versus “directly adjacent,” and the like.

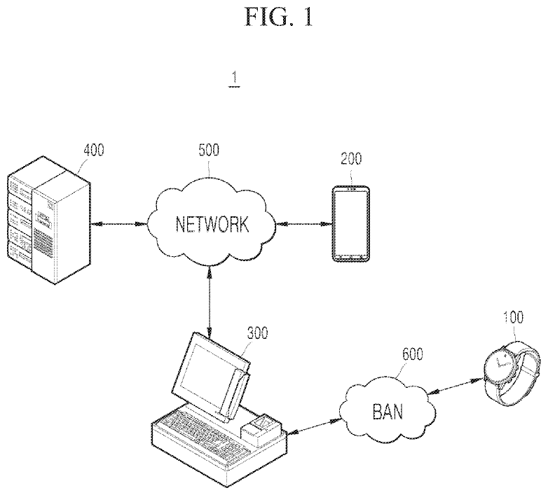

FIG. 1 is an exemplary view of a network environment of a payment system 1 based on biometrics according to an embodiment of the present disclosure.

Referring to FIG. 1, the payment system 1 according to this embodiment of the present disclosure may include a user device 100, a user terminal 200, an electronic payment device 300, a payment server 400, and a network 500 for connecting the user device 100, the user terminal 200, the electronic payment device 300, and the payment server 400 to one another. However, each component is not essential to the payment system 1, and thus some components may be excluded from the payment system 1.

For convenience of explanation, a situation in which a user, acting as a payer, visits a business site of a merchant, purchases a product, and makes a payment for the product by using a measure for electronic payment as a benefit of return will be described as an example of a payment system according to an embodiment of the present disclosure. Here, a business operator corresponds to the merchant, with respect to a company that runs a payment business by using a measure for electronic payment, such as a credit card company.

The user may carry the user device 100 and may further carry the user terminal 200. FIG. 1 illustrates the user device 100 as a wearable device that is in the form of a wristwatch, and illustrates the user terminal 200 as a communication terminal that is in the form of a cellular phone. However, forms of the user device 100 and the user terminal 200 are not limited to the forms illustrated in FIG. 1, and the user device 100 and the user terminal 200 may be implemented as a mobile terminal having various forms.

The user device 100 may serve to transmit payment specific information to the electronic payment device 300 in response to a payment request of the business operator. Here, the payment specific information may include information about a measure for electronic payment, for example, a modified credit card such as a universal subscriber identity module (USIM) card or an AppCard. The information, for example, may include all or some of a card number, a card expiration date, a card security code, and a password. The payment specific information may be stored in the user device 100.

The payment specific information may be stored in the user device 100 in an encrypted state. The payment specific information stored in the encrypted state may be transmitted to the payment server 400 via the electronic payment device 300. The payment server 400 may decrypt the encrypted payment specific information and determine whether to approve the user.

Referring back to FIG. 1, the user device 100 may be communicatively connected with the electronic payment device 300 via a body area network (BAN). Accordingly, the user device 100 may be implemented in the form of a wearable device. When the user wears the wearable device on the body and a part of the user's body is communicatively connected to an input interface of the electronic payment device 300, an overall communication connection between the user device 100 and the electronic payment device 300 may be performed.

The user terminal 200 is not an essential component, but may assist the user device 100. For example, when a template of the payer is not stored in the user device 100, the user terminal 200 may transmit the template stored in the user terminal 200 to the user device 100.

The template denotes registered or stored biometric data which is obtained by extracting biometric features. In the present disclosure, the template of the payer refers to the template in which features of a biometric image, excluding unnecessary information, are encoded via an input interface, for example, a sensor. For example, a fingerprint recognition system may use a feature of a fingerprint that is in a code of about 400 bytes instead of a fingerprint image itself, for efficient storage and matching.

The user terminal 200 is a device capable of wired and wireless communication and capable of performing a function of a computing device. Preferably, the user terminal 200 is a wireless terminal capable of wireless communication and assisting the user device 100.

Various embodiments of the wireless terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device, an appliance for storing and playing music having a wireless communication function, an Internet appliance capable of accessing and browsing wireless Internet, and a portable unit or terminal incorporating combinations of such functions, but are not limited to those functions.

The user device 100 and the user terminal 200 may perform a function of a voice agent. The voice agent may be a program configured to recognize a voice of a user and output a voice corresponding to the voice of the user.

The electronic payment device 300 is a device which is installed in a business site to help payment of a payer who received a payment request from a business operator. The electronic payment device 300 may be implemented as a terminal of a system called a point of sale (POS) having various functions such as order processing, payment, store management, inventory, and the like.

The fingerprint recognition device 310, which is a component of the electronic payment device 300, may collect biometric information, especially user fingerprint information. In addition, the electronic payment device 300 may include various types of input interfaces, such as a sensor, configured to collect biometric information depending on the type of the biometric information. A feature of the collected biometric information, that is, fingerprint information, may be stored as an encrypted code. Since the electronic payment device 300 transmits, to the user device 100, the encrypted code and a key used for decryption simultaneously, the encrypted code and the key used for decryption may not be stored in the electronic payment device.

The payment server 400 may approve of payment specific information provided by the electronic payment device 300 via the user device 100. Specifically, the payment server 400 may include a server managed by a single business operator or a plurality of business operators. For example, the payment server 400 may include a server of a credit card company, and further include a server of a value added network (VAN) provider that establishes a communication network between merchants; provides services of recruiting merchants, approving of transactions, purchasing, managing merchants, and the like; and receives a predetermined fee for the services.

The network 500 may be a wired and wireless network, for example, a local area network (LAN), a wide area network (WAN), Internet, an intranet and an extranet, and any suitable communication network including a mobile network, such as cellular, 3G, LTE, 5G, and Wi-Fi networks, ad hoc networks, and a combination of the listed networks.

The network 500 may include a connection of network elements such as a hub, bridge, router, switch, and gateway. The network 500 may include one or more connected networks, for example, a multi-network environment including a public network such as the Internet and a private network such as a secure corporate private network. Access to the network 500 may be provided via one or more wired or wireless access networks.

The BAN 600 is a type of network that connects electronic devices around a body with each other by using the body as a transmission medium, thus allowing communications. Standardization for wireless body area network (WBAN) is being conducted by task groups (TG) included in IEEE 802.15 working groups for a wireless personal area network (WPAN).

A WBAN standard is aimed at standardization for short-range, low-power, and high-reliability wireless communication. The WBAN, which has a transmission speed ranging from several kbps to tens of mbps according to the intended use of the WBAN, may be used for medical use and non-medical use. The WBAN for medical use may be used for an implantable device that is implanted in a body and a wearable device that is worn on a body, and the WBAN for non-medical use may be used in various entertainment fields such as data transmission, game applications, and the like.

A body communication technology using the BAN 600 may use an electric current passing through a human body by using the human body as a medium, like a wire, without consuming any electric power, and may transmit various types of data by using parts of the human body such as arms, legs or the like.

Hereinafter, a user authentication process occurring between a user device and an electronic payment device according to an embodiment of the present disclosure will be described.

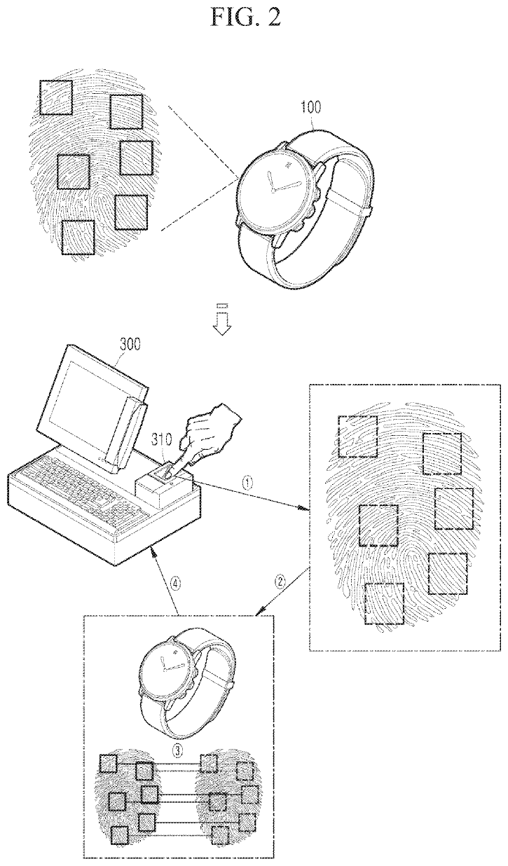

FIG. 2 is an exemplary view of a user device and an electronic payment device according to an embodiment of the present disclosure.

FIG. 2 illustrates a user device 100 that stores biometric information of a user, especially fingerprint information.

The biometric information may be a physical feature inherent to each individual. The biometric information according to this embodiment of the present disclosure may include at least one selected from a group of information about a face, information about a fingerprint, information about an iris, information about a retina, information about a voice, information about a vein, information about a hand shape, and information about an ear shape.

Depending on the type of biometric information, an electronic payment device 300 may detect the biometric information of the user by using an input interface capable of detecting the corresponding biometric information. For example, the input interface may include a fingerprint input device configured to detect fingerprint information; a camera configured to recognize a face, an iris, a retina, a vein, a hand shape, and an ear shape; an image processing device configured to process an image photographed by the camera; and a voice recognition device configured to recognize a voice.

A user may place his or her finger on a flat surface of an image acquiring device so as to use the fingerprint input device. Most fingerprint recognition devices for personal use may store feature information extracted from an original fingerprint image without storing the original fingerprint image as original data. Such systems may not reproduce the original fingerprint image from registered fingerprint data, and accordingly, the systems may not be used as a legal proving method, but may perform a function of protecting personal information. In addition, recently released fingerprint recognition devices may check whether a finger is a finger of a living person while scanning a finger. This is to prevent an unauthorized user from using a forged fingerprint to impersonate an authorized user.

A biometrics technology that extracts a measurable physical feature of a person, compares the extracted physical feature with a physical feature of the user, and verifies whether the person is the user has no risk of loss or theft. In addition, the biometrics technology, which has a high security effect and convenience in that it utilizes a part of a body, has been receiving attention as a next-generation information security technology.

A fingerprint recognition system generally employs an algorithm that extracts, stores, and compares positions and properties of feature points composed of bifurcation points and endpoints of fingerprint ridges. An error rate that is greatly increased when a scanner contains sweat or moisture, discomfort of placing a finger on a portion with which many fingers of other people make contact, and deteriorating fingerprints have all been recognized as limitations of the fingerprint recognition system.

The user device 100 may store the user's fingerprint information authenticated by an authentication center via a strict security procedure. Body information, which forms a basis for authenticating the user, such as the user's fingerprint information stored in advance, is called a template. The user device 100 may be implemented in the form of a wearable device.

The electronic payment device 300 communicatively connected with the user device 100 via the BAN 600 is illustrated in the middle of FIG. 2. The user may carry the user device 100, which is in the form of a cellular phone on his or her body, hold the user device 100 in his or her hand, or wear the user device 100 that is in the form of a wearable device on his or her wrist. In this state, the user may bring his or her finger into contact with the input interface of the electronic payment device 300, thus being capable of performing a communication connection between the user device 100 and the electronic payment device 300 via the BAN 600.

When the user brings his or her finger into contact with the input interface of the electronic payment device 300, for example, the fingerprint input device 310, the electronic payment device 300 may detect the user's fingerprint information, and the detected fingerprint information may be transmitted to the user device 100 via the BAN 600.

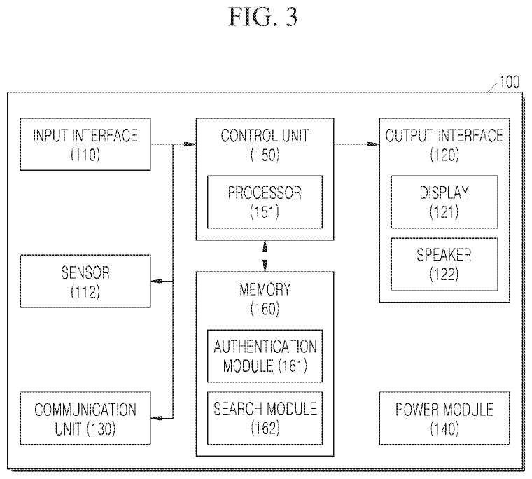

FIG. 3 is a block diagram of a user device according to an embodiment of the present disclosure.

Referring to FIG. 3, a user device 100 may include an input interface 110, an output interface 120, a communication unit 130, a power module 140, a control unit 150, and a memory 160.

The input interface 110 may include a user input unit configured to receive information from a user. When information is inputted via the user input unit, a processor 151 may control an operation of the user device 100 according to the inputted information.

The user input unit may include a mechanical type input tool (or a mechanical key, such as a button located on front and rear surfaces or a side surface of the user device 100, a dome switch, a jog wheel, a jog switch, and the like) and a touch type input tool. As an example, the touch type input tool may include a virtual key, a soft key, or a visual key displayed on a touch screen via software processing, or may include a touch key disposed on any portion other than the touch screen.

A sensor 112 may include at least one of a proximity sensor; an illumination sensor; a touch sensor; an acceleration sensor; a magnetic sensor; a gravity (G) sensor; a gyroscope sensor; a motion sensor; a red, green, and blue (RGB) sensor; an infrared (IR) sensor; a finger scan sensor; an ultrasonic sensor; an optical sensor such as a camera; a microphone; a battery gauge; an environmental sensor such as a barometer, a hygrometer, a thermometer, a radiation sensor, a thermal sensor, a gas sensor, and the like; and a chemical sensor such as an electronic nose, a healthcare sensor, a biometric sensor, and the like.

The output interface 120 may include a display 121 and a speaker 122.

The display 121 may form a mutual layer structure with the touch sensor or may be formed integral with the touch sensor, thus being capable of implementing a touch screen. The touch screen may provide the input interface 110 between the user device 100 and the user, and simultaneously may provide the output interface 120 between the user device 100 and the user.

The communication unit 130 may include at least one of a mobile communication module and a wireless Internet module. In addition, the communication unit 130 may further include a short-range communication module.

The mobile communication module may transmit and receive wireless signals to and from at least one of a base station, an external terminal, and a server on a mobile communication network established according to technical standards or communication methods for mobile communications, for example, global system for mobile communication (GSM), code division multi access (CDMA), wideband CDMA (WCDMA), high speed downlink packet access (HSDPA), long term evolution (LTE), and the like.

The wireless Internet module, which is configured to facilitate wireless Internet access, may be internally or externally coupled to the user device 100. The wireless Internet module may transmit and receive wireless signals via a communication network according to wireless Internet technologies.

For example, the wireless Internet technologies may include wireless LAN (WLAN), wireless fidelity (Wi-Fi), Wi-Fi Direct, digital living network alliance (DLNA), wireless broadband (WiBro), worldwide interoperability for microwave access (WiMAX), high speed downlink packet access (HSDPA), high speed uplink packet access (HSUPA), LTE, LTE-Advanced (LTE-A), and the like.

The short-range communication module, which is configured to facilitate a short-range communication, may support the short-range communication by using one of technologies, such as Bluetooth™, radio frequency identification (RFID), infrared data association (IrDA), ultra-wideband (UWB), ZigBee, near field communication (NFC), Wi-Fi, Wi-Fi Direct, wireless universal serial bus (Wireless USB), and the like.

The communication unit 130 may perform a communication connection with an electronic payment device 300 via the BAN 600 and receive the user's biometric information detected by the electronic payment device 300.

The power module 140 may receive external power and internal power under the control of the processor 151 and supply power to respective components included in the user device 100. The power module 140 may include a battery. The battery may be an embedded battery or a replaceable battery. In addition, the power module 140 may include a charging circuit, a discharging circuit, and a protection circuit.

The control unit 150 may include the processor 151. The processor 151 may control the input interface 110, the sensor 112, the output interface 120, the communication unit 130, and the power module 140, and may control a user authentication process occurring between the user device 100 and the electronic payment device 300 by using an authentication module 161 and a search module 162 stored in the memory 160.

The memory 160 may include or store the authentication module 161 and the search module 162.

The authentication module 161 and the search module 162 may be implemented in the form of a program that can be read and executed by the processor 151 of the user device 100.

The processor 151 may perform user authentication by comparing a user template with user biometric information via the authentication module 161.

The processor 151 may search the template in the user device 100 via the search module 162. In addition, the processor 151 may search a copy of the user template by using the search module 162 in a state where a communication connection with the authentication center is performed.

The processor 151 may generally control overall operation of the user device 100 in addition to operations associated with the authentication module 161 and the search module 165. The processor 151 may process signals, data, information, and the like inputted or outputted via the above-described components, and execute an application program stored in the memory 160, thus being capable of providing appropriate information or functions to the user or processing the appropriate information or functions.

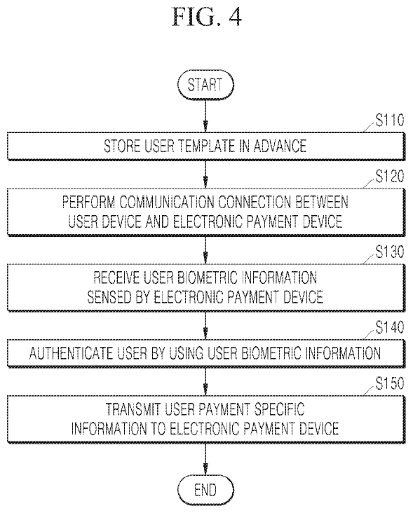

FIG. 4 is a flowchart of a payment method based on biometrics according to an embodiment of the present disclosure.

Referring to FIG. 4, a payment method based on biometrics S100 may include steps S110 to S150.

A user device 100 may store a user template in advance (S110). The user template denotes registered or stored biometric information, or biometric data, which is obtained by extracting biometric features. In the present disclosure, a template of a payer refers to a template in which features of a biometric image, excluding unnecessary information, are encoded via the input interface 110, for example, the sensor 112.

A user who carries the user device 100 on his or her body, or wears the user device 100 in the form of a wearable device may bring a part of his or her body into contact with the input interface of an electronic payment device 300, thus being capable of performing a communication connection between the user device 100 and the electronic payment device 300 via a BAN 600. In addition, the user device 100 may be communicatively connected to the electronic payment device 300 via a short-range communication. The electronic payment device 300 may request the user device 100 to authenticate the user using the biometric information via the communication connection.

Next, the user device 100 may receive the user's biometric information detected by the electronic payment device 300 required for user authentication (S130).

Next, the user device 100 may perform user authentication by using the user's biometric information (S140). Specifically, the user device 100 may determine whether the user's biometric information is consistent with the template stored in advance. When the biometric information is a fingerprint, the user device 100 may determine whether a feature of a fingerprint stored in the user's biometric information and a feature of a fingerprint stored in the template are consistent with each other since the user's biometric information and the template are collected and stored mainly in terms of a feature, not an overall image.

When the template and the user's biometric information are consistent with each other, the user device 100 may transmit the user's payment specific information to the electronic payment device 300 (S150). For example, when a feature of a fingerprint stored in advance in the user device 100 and a feature of the user's fingerprint received are consistent with each other, the user device 100 may transmit payment specific information of a measure for electronic payment, such as a USIM card or an AppCard, to the electronic payment device 300.

The payment method S100 described in the aspect of the user device 100 may also be described in the aspect of the electronic payment device 300.

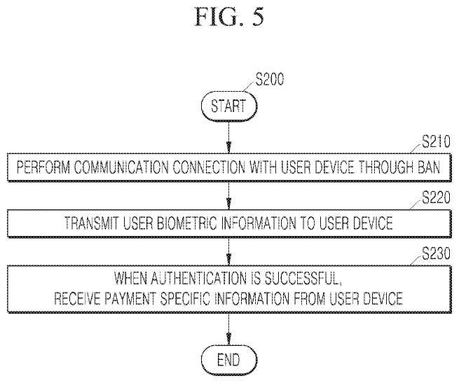

FIG. 5 is a flowchart of a payment method according to an embodiment of the present disclosure described in the aspect of an electronic payment device.

Referring to FIG. 5, a payment method (S200) based on biometric information according to an embodiment of the present disclosure may include steps S210 to S230.

First, an electronic payment device 300 may be communicatively connected to a user device 100 via a BAN 600 (S210).

Next, the electronic payment device 300 may transmit a user's biometric information, obtained from detection of the user, to the user device 100 supporting the BAN 600 (S220).

Next, when a user authentication performed via collation of the user's biometric information and a template of the user is successful, the electronic payment device 300 may receive payment specific information from the user device 100 (S230). Then, the electronic payment device 300 may request for a user approval to a payment server 400 by using the payment specific information.

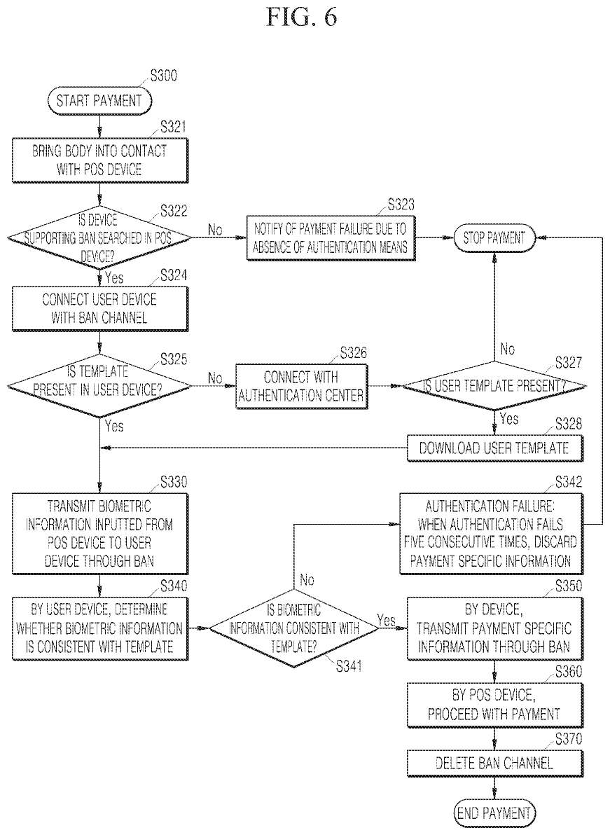

FIG. 6 is a flowchart of a payment method based on biometrics according to an embodiment of the present disclosure.

FIG. 6 illustrates a payment method based on biometric information performed by a user device 100 and an electronic payment device 300 which are communicatively connected via a BAN 600. A POS device illustrated in FIG. 6 is an example of the electronic payment device 300.

The electronic payment device 300 and the user device 100 may be connected to each other via a user's body. That is, the user who has received a payment request may contact a POS device 300 with his or her finger to commence biometric-based payment (S121). In a state where the user wears a wearable device 100 on his or her wrist, the user may bring a part of the body, such as a finger, into contact with the recognition surface of a fingerprint recognition device 310 of the POS device 300.

When there is a request for communication connection via the BAN 600 via finger contact, the POS device 300 may search whether there is the user device 100 supporting the BAN 600 (S322).

When the user device 100 is found, the POS device 300 and the user device 100 may be communicatively connected to each other via a BAN channel (S324).

Next, the POS device 300 may search whether a template required for user authentication is stored in the user device 100 (S325).

When the POS device 300 is successful in the template search, the POS device 300 may transmit user biometric information inputted via the fingerprint input device 310, that is, fingerprint information to the user device 100 via the BAN 600 (S330). In this case, the POS device 300 may request the user device 100 to determine whether the user biometric information is consistent with the template stored in the user device 100 for user authentication.

The user device 100 receiving an authentication request from the POS device 300 may determine whether the user biometric information is consistent with the template (S340).

When it is determined that the user biometric information is consistent with the stored template, the user device 100 may transmit a user's payment specific information to the POS device 300 via the BAN 600 (S350).

The POS device 300 may proceed with payment by using the received payment specific information (S360).

After the payment is completed, the POS device 300 may delete the BAN channel created between the POS device 300 and the user device 100 (S370).

When the template search fails, the user device 100 may perform a communication connection with an authentication center so as to download a template (S326).

Then, the user device 100 may search whether there is a corresponding template (S327). When the corresponding template having been issued to the user in the past exists, a copy of the template may be stored in the authentication center.

Next, the user device 100 may download the copy of the template stored in the authentication center (S328).

The authentication may fail when it is determined that the biometric information is consistent with the stored template, For example, when authentication fails five consecutive times, the user device 100 may discard the stored payment specific information (S342).

In the embodiments of the present disclosure, the above-described payment method can be implemented as a computer-readable code in program recorded media. The computer-readable media includes all types of recording devices in which data readable by a computer system is stored. For example, the computer-readable media may include a hard disk drive (HDD), a solid state disk (SSD), a silicon disk drive (SDD), a ROM, a RAM, a CD-ROM, a magnetic tape, a floppy disk, optical data storage devices, and the like. Further, the computer may include the processor 151 of the user device.

As described above, according to various embodiments of the present disclosure, authenticating a user by using biometric information of the user without disclosing the biometric information of the user is possible, and thus there is no fear of leakage of personal information.

Further, performing user authentication required for payment via a BAN and by using biometric information is possible.

Many modifications to the above embodiments may be made without altering the nature of the invention. The dimensions and shapes of the components and the construction materials may be modified for particular circumstances. While various embodiments have been described above, it should be understood that they have been presented by way of example only, and not as limitations.

What is claimed is:

1. A payment method performed by a user device of a payer according to to a payment request of an electronic payment device, the payment method comprising:
performing, by the user device, a communication connection with the electronic payment device;
receiving biometric information of the payer detected by the electronic payment device;
authenticating the payer by using the biometric information of the payer; and
transmitting payment specific information to the electronic payment device, when a payer authentication is successful.

2. The payment method according to claim 1, further comprising:
storing, in advance, a template required for the payer authentication,
and wherein the authenticating the payer comprises determining whether the template and the biometric information of the payer are consistent with each other.

3. The payment method according to claim 2, wherein
the storing, in advance, the template comprises receiving the template from a user terminal.

4. The payment method according to claim 1, further comprising:
searching the template; and
downloading the template from an authentication center, when the template is not found in a local area.

5. The payment method according to claim 4, wherein
the downloading the template comprises:
connecting with the authentication center via a network;
determining whether the template is registered; and
downloading the template, when the template is registered.

6. The payment method according to claim 1, wherein
the performing, by the user device, the communication connection with the electronic payment device comprises performing the communication connection via a body area network (BAN).

7. The payment method according to claim 1, wherein
the authenticating the payer by using the biometric information of the payer comprises verifying whether the biometric information of the payer and the template are consistent with each other.

8. The payment method according to claim 1, wherein
the biometric information includes at least one selected from a group of information about a face, information about a fingerprint, information about an iris, information about a retina, information about a voice, information about a vein, information about a hand shape, and information about an ear shape.

9. The payment method according to claim 1, further comprising:
discarding the payment specific information, when the payer authentication fails a predetermined number of times.

10. The payment method according to claim 1, wherein
the biometric information of the payer detected by the electronic payment device is transmitted to the user device of the payer without being stored in the electronic payment device.

11. A user device, comprising:
a communication unit configured to perform a communication connection with an electronic payment device and receive biometric information of a payer detected by the electronic payment device; and
a processor configured to perform payer authentication by using the biometric information of the payer,
wherein the processor is configured to control the communication unit so as to transmit payment specific information to the electronic payment device via a BAN, when the payer authentication is successful.

12. The user device according to claim 11, further comprising:
a memory configured to store a template required for the payer authentication,
and wherein the processor is configured to determine whether the template stored in advance and the biometric information of the payer are consistent with each other.

13. The user device according to claim 12, wherein
the processor is configured to control the communication unit so as to receive the template from a user terminal of the payer.

14. The user device according to claim 11, wherein
the processor is configured to:
search the template, and
control the communication unit so as to download the template from an authentication center, when the template is not found in a local area.

15. The user device according to claim 11, wherein
the communication unit is configured to perform the communication connection with the electronic payment device via the BAN.

16. The user device according to claim 11, wherein
the processor is configured to authenticate the payer by verifying whether the biometric information of the payer and the template are consistent with each other.

17. The user device according to claim 11, wherein
the biometric information includes at least one selected from a group of information about a face, information about a fingerprint, information about an iris, information about a retina, information about a voice, information about a vein, information about a hand shape, and information about an ear shape.

18. The user device according to claim 11, wherein
the processor is configured to discard the payment specific information, when the payer authentication fails a predetermined number of times.

19. The user device according to claim 11, wherein
the biometric information of the payer detected by the electronic payment device is transmitted to the user device of the payer without being stored in the electronic payment device.

20. A payment system based on biometrics, the payment system comprising:
a user device of a payer configured to perform payer authentication by determining whether a template stored in advance and biometric information of the payer detected are consistent with each other and supply specific information about the payer to a payment; and
an electronic payment device of a merchant configured to generate biometric information of the payer and proceed with payment by using the specific information about the payer received according to the payer authentication.
